(19) United States
(12) Patent Application Publication
(10) Pub. No.: US 2012/0229514 A1
(43) Pub. Date: Sep. 13, 2012

(54) TRANSITIONING PRESENCE INDICATION THROUGH ANIMATION

(75) Inventor: Mehrdad Mozafari, Redmond, WA (US)

(73) Assignee: MICROSOFT CORPORATION, Redmond, WA (US)

(21) Appl. No.: 13/045,006

(22) Filed: Mar. 10, 2011

(51) Int. Cl. G06T 3/60; G09G 5/02; G06T 13/00

(52) U.S. Cl. 345/653; 345/473; 345/589

(57) ABSTRACT

Presence indication representing a variety of presence information is transitioned through an animation into another indication upon detecting a presence status update event. The animation takes a variety of forms such as rotation, enlargement, or reduction of the initial presence indication. The animation completes within a predetermined time period or a dynamic time period, which is adjusted based on a time period between user interactions with the client application.

### BACKGROUND

The proliferation of capabilities and services provided through communication devices by newer systems combine a variety of short range and long range communication capabilities over a number of networks including traditional phone networks, wireless networks, and similar ones. Telecommunication end devices as well as support devices and programs for such newer systems are more similar to computer networks than conventional telephone networks. Thus, a large number of capabilities may be added to those already provided by modern telecommunication devices and networks. For example, instant messaging, voice/video communications, and other forms of communication may be combined with presence and availability information of subscribers.

In modern platforms, subscribers partake in rich user applications displaying multitude of information about contacts. The information displayed varies depending on application and device capabilities. Certain applications such as desktop client applications have more space to display users extensive details about the user's contacts. While other applications, such as mobile communication applications, are limited to available screen size to display as much contact information as possible, efficiently.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to transitioning a presence indication through an animation. A user application may display an initial presence indication representing a contact status. The user application may receive a presence update event from an external entity. Upon detecting the update event, the user application may transition the initial presence indication into a new presence indication through an animation to represent the contact's presence status change.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 is a diagram illustrating example components of a system transitioning a presence indication through an animation;

FIG. 2 illustrates an example action diagram of a presence indication transition;

FIG. 3 illustrates an example presence indication animation according to some embodiments;

FIG. 4 is an example implementation of updating a presence indication through an animation;

FIG. 5 is a networked environment, where a system according to embodiments may be implemented;

FIG. 6 is a block diagram of an example computing operating environment, where embodiments may be implemented; and

FIG. 7 illustrates a logic flow diagram for a process of transitioning a presence indication through an animation according to embodiments.

### DETAILED DESCRIPTION

As briefly described above, a presence indication may be transitioned to another in an animated manner. A user application may display an initial presence indicator representing a contact status. The user application may receive a presence update event from an external entity. Upon receiving the update event, the user application may transition the initial presence indicator to a new presence indicator through an animation to represent the presence status update. Furthermore, the use of an animation to indicate the presence status change may improve the user application's visual appeal. In the following detailed description, references are made to the accompanying drawings that form a part hereof, and in which are shown by way of illustrations specific embodiments or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While the embodiments will be described in the general context of program modules that execute in conjunction with an application program that runs on an operating system on a computing device, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium can for example be implemented via one or more of a volatile computer memory, a non-volatile memory, a hard drive, a flash drive, a floppy disk, or a compact disk, and comparable physical storage media.

Throughout this specification, the term “platform” may be a combination of software and hardware components for providing presence based services. Examples of platforms include, but are not limited to, a hosted service executed over a plurality of servers, an application executed on a single server, and comparable systems. The term “server” generally refers to a computing device executing one or more software programs typically in a networked environment. However, a server may also be implemented as a virtual server (software programs) executed on one or more computing devices viewed as a server on the network. More detail on these technologies and example operations is provided below.

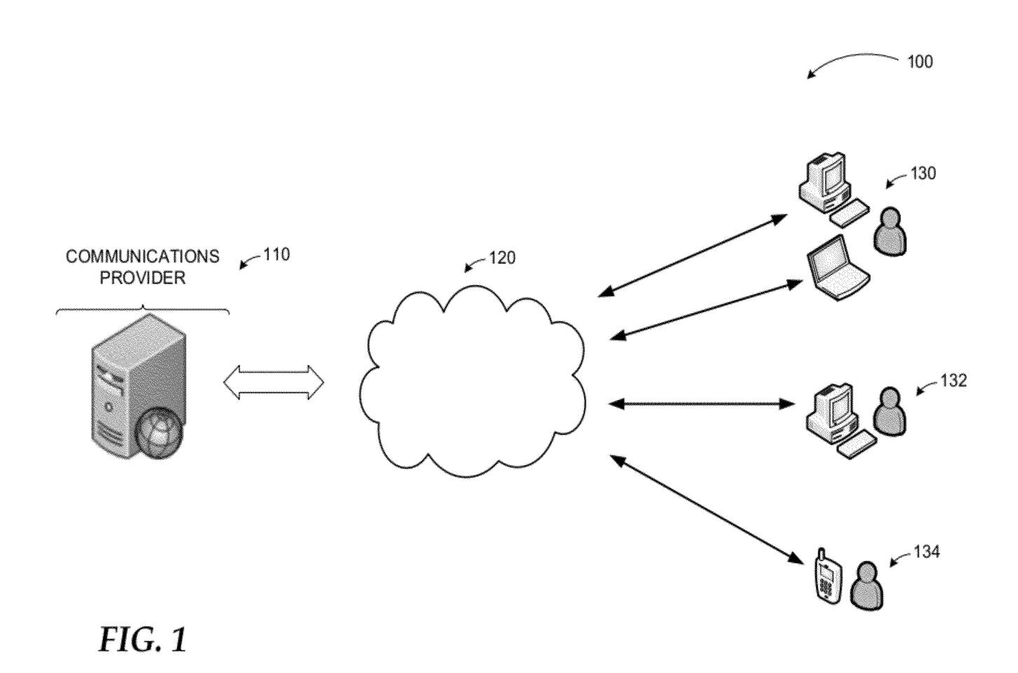

FIG. 1 is a diagram illustrating example components of a system transitioning a presence indication through an animation. In diagram 100, the server 110 may host a communications provider facilitating a variety of communications among client devices, including but not exclusive to message, audio, and video communications, via network 120. The network 120 may be a local network or may be an external entity such as an internet based infrastructure. It may provide wired or wireless connectivity. Network nodes may connect to each other through unsecured or secured connectivity. An example of a secured connectivity may be a Virtual Private Network (VPN) established among the network nodes with the use of encrypted communications.

The server 110 may facilitate communications between clients 130, 132, and 134 through a variety of protocols, an example of which may be the Session Initiation Protocol (SIP). The server can initiate, route, and manage single or multiple communication sessions between clients and client applications. The clients may track each other's status by sending user presence information to the server. Presence information may include a wide range of data associated with each contact such as their location, availability, contact information details, alternative contacts, organizational information, and comparable data. A presence indication may represent the status embedded within the prior presence information categories. An indication as used herein may include a symbol such as an icon and/or text describing the represented entity such as the presence status. The server may transmit user presence information to clients to refresh users' presence information. Client and server presence information transmissions may be on a predetermined schedule. Alternatively, presence information transmissions may be dynamically updated as needed upon presence change events from clients or through other schemes. Updates are reflected on client applications through changes to contact presence indications employing animations.

In an alternative embodiment, the clients may transmit presence information to each other through a peer to peer architecture. Clients may retrieve peer location information such as Internet Protocol (IP) addresses from a central repository and establish connections to each other. Clients may maintain peer connections and transmit user presence information updates to each other. Updates are reflected on client applications through changes to contact presence indications through animations. Embodiments are not limited to client/server and peer to peer architectures. Presence information updates reflected through animated transition may be transmitted using other architectures.

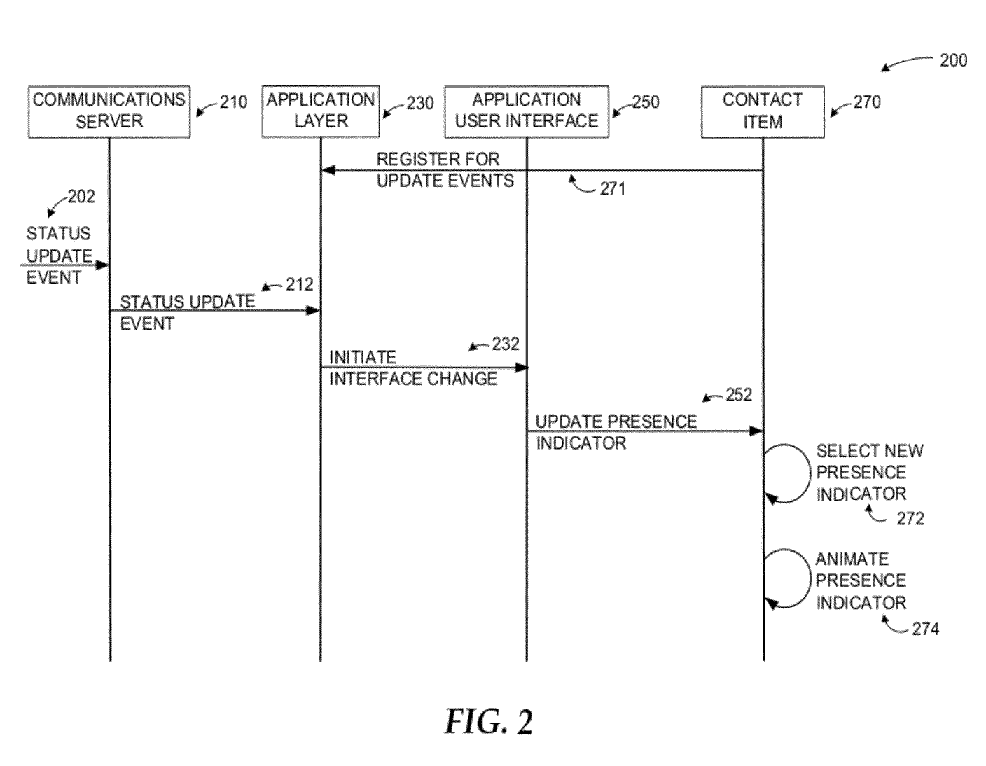

FIG. 2 illustrates example action diagram of a presence indication transition. A system according to embodiments transitions a presence indication into another through an animation upon detecting a presence status update event. A user application may execute the animation representing the presence status update. In an example scenario, the user application may receive a presence status update event form an external entity. The external entity may be a communications server facilitating presence information exchange among clients. Upon detecting the update, the client may update the initial presence indication into a new indication by using an animated transition.

Diagram 200 illustrates some example concepts in transitioning a presence indication through an animation according to embodiments. Before presence updates are exchanged, a contact item 270 in a client application (application layer 230) may be registered for update events with a communication server 210. The communications server 210 detects a presence status update event 202 from another client application, another server, or comparable entity. The event may be a message such as extensible markup language (XML) formatted message describing the presence update of a contact. The server may decipher the event and determine the destination of the event from the stored information within the event. Upon determining the destination, the server may transmit the presence status update event 212 to its destination.

The transmitted presence status update event is intercepted by the application layer 230 of a receiving client application. The application layer 230 may determine the event type and how to respond to it. The application layer 230 may initiate an interface change 232 by calling the necessary application user interface 250 methods. The executed application user interface 250 methods may update the presence indicator (252) displayed on the user interface per the update event information. In an example scenario, the status event may indicate a contact's presence to be updated to unavailable. Accordingly, a contact item 270 displayed on the user interface may be altered to reflect the updated presence status by selecting a new presence indicator 272 and animating the update to the new presence indicator 274.

In an example scenario, the contact item may be represented by icons and/or texts. The representative icon may be changed using animation to reflect the presence status update. The animation may be a rotation of the icon on its x-axis completed within a predetermined time period. During the rotation the icon may be transitioned to a faded version to indicate an unavailable contact. Alternatively, the animation time period may be dynamically altered to fit a user's interaction period. A user's interaction period may be how often the user interacts with the client application. A growing time period between interactions may be used to calculate a proportionally growing animation period. Alternatively, declining time period between user interactions with the client application may be used to calculate a proportionally declining animation period. In some implementations, the animation period may be less than 0.7 seconds. However, the animation period may be set manually by the user by adjusting a client application setting.

The described animations are for illustration purposes. Other animations may be used to transition a presence status indication into another.

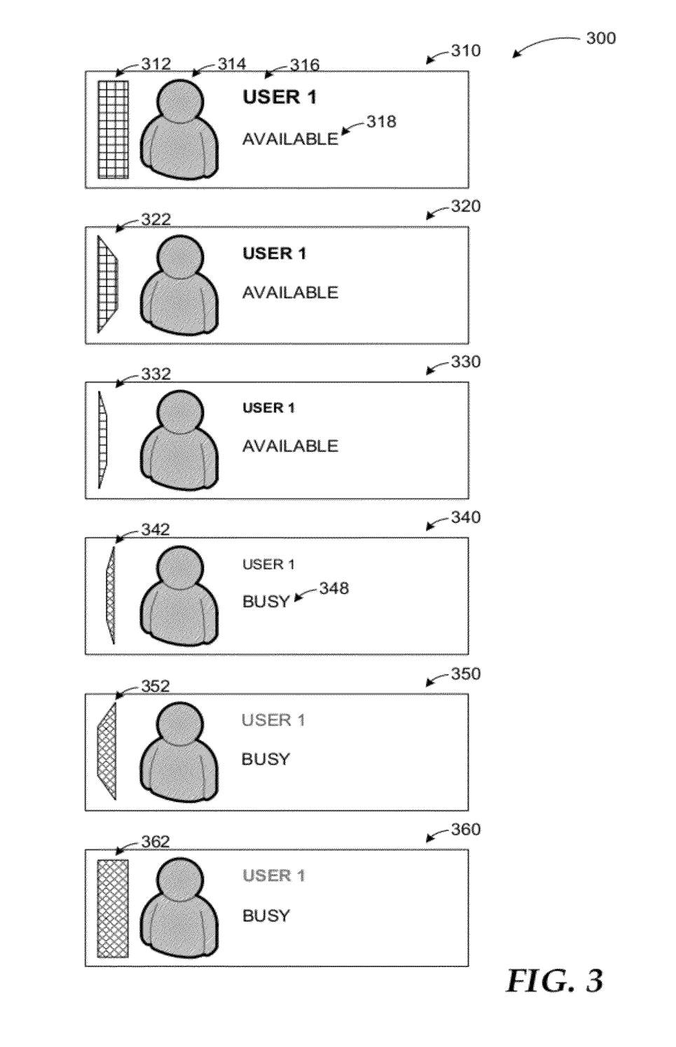

FIG. 3 illustrates an example presence indication animation according to some embodiments. Diagram 300 illustrates stages of an animated transition of a presence indicator. Presence indicator 310 displays a bar 312, an icon 314 representing a user, a user name such as ‘USER 1’ 316, and the user's status as ‘AVAILABLE’ 318. Upon detecting a presence status change event, the user interface may initiate an animation to transform the presence indicator into another while updating the user's status.

The presence indicator 320 includes an example of a rotation based transition, where bar 322 is rotated along a y-axis while giving the appearance of the bar shrinking towards the far perspective. At the same time a font size (and boldness) of the text is reduced as well. Presence indicator 330 represents a continued animation of the transition while the bar 332 continues its y-axis rotation. The reduction of size/boldness of the text font is also continued while the user status is still ‘AVAILABLE’.

At some point during the transition, presence indicator 340 is changed to reflect the user status 348 as ‘BUSY’ while the bar continues its y-axis rotation. The animated transition continues in presence indicators 350 and 360 as the bar completes its rotation (352 and 362) with the transition of the text characteristics also being completed in presence indicator 360. Additionally, a texture of the bar, a color, shading, brightness, etc. of the icon 314 and/or the bar 312 may also be modified in an animated (e.g., gradual) manner. Similarly, changes to various properties of the textual parts of the presence indicator 310 may be implemented in an animated manner (e.g. text may also be rotated, blended, appear, disappear, etc.).

The animation above is provided as an example embodiment. Other animations may be used to transition an initial presence indication into another. Any rotation in x, y, and z axis may be used to animate. Combination of x, y, and z axis complete rotations (360 degrees) may be used. Partial rotations encompassing angle ranges for each of the x, y, and z axis may be used individually or in combination to animate the presence indication. Enlargement and reduction of the initial presence indication into another indication may be used alone or in combination with x, y, and z rotations covering complete and partial rotations. In addition, the initial presence indication may be transformed into another by blending the two or three dimensional view of the initial presence indication into the new presence indication. The blending may form multiple middle indications having properties of both the indications such as combined colors, shape, and structures. The blending may be gradual and applied based on the animation time period. Animation time period may be predetermined or dynamic for any animation as described previously.

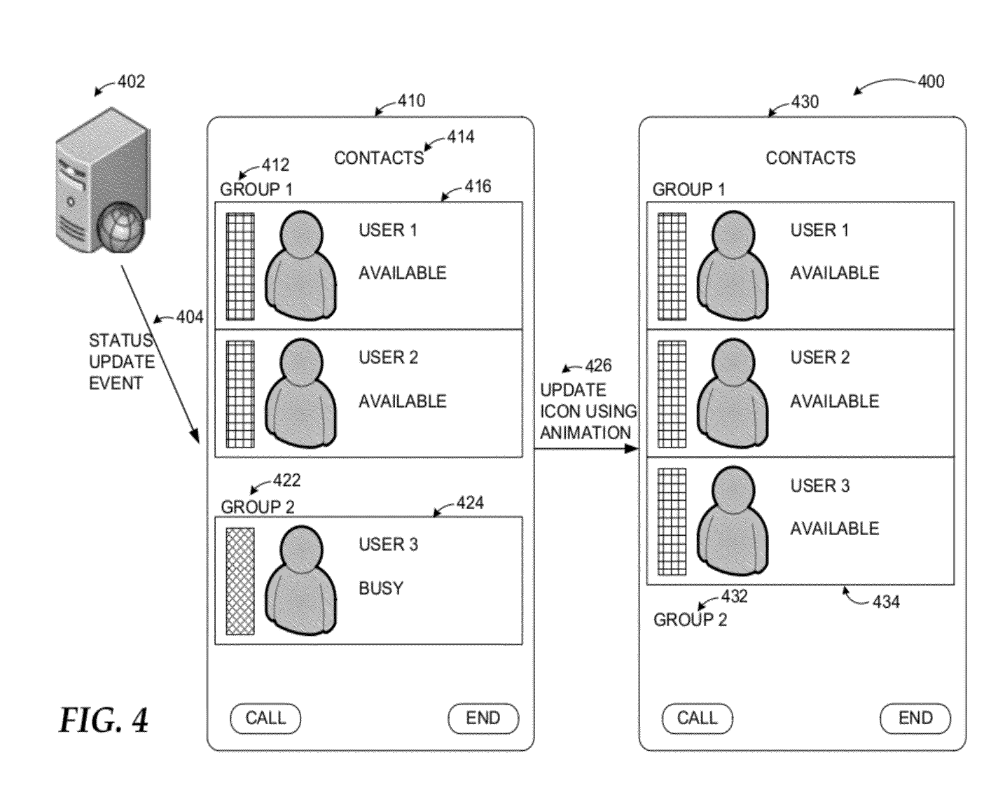

FIG. 4 is an example implementation of updating a presence indication through an animation. In diagram 400, an example of presence indicator update through an animation is displayed on a smart phone user interface. The smart phone may receive a presence status update event 404 from server 402. The smart phone may display on its user interface 410 a list of contacts 414 grouped into two groups: ‘GROUP 1’ 412 showing ‘AVAILABLE’ contacts 416, and ‘GROUP 2’ 422 showing ‘BUSY’ contact 424.

Upon receiving the update event, the smart phone may initiate an update 426 of the presence indicator 424 through an animation in order to notify the user. The update may result in moving the contact 434 from ‘GROUP 2’ 432 to ‘GROUP 1’ on user interface 430. Additionally, USER 3's status may be changed from ‘BUSY’ to ‘AVAILABLE’. Presence indicator texture may also be changed with an animation from the previous texture. The animation may be done by any of the above discussed examples.

Additionally, to fit platform specific requirements, the animation may be restricted to a subset of available animations. A restricted subset of animations may aid in system requirements such as meeting available power limitations. An example may be changing the texture of the presence indication to reserve battery power instead of rotating the presence indication and utilizing more processing power therefore more battery power.

The systems and implementations of transitioning a presence indication through an animation discussed above are for illustration purposes and do not constitute a limitation on embodiments. Transitioning a presence indication through an animation may be implemented by an application layer and an application user interface. The animation may take a variety of formats including rotation of the presence indication. The animation may be implemented employing other modules, processes, and configurations using the principles discussed herein.

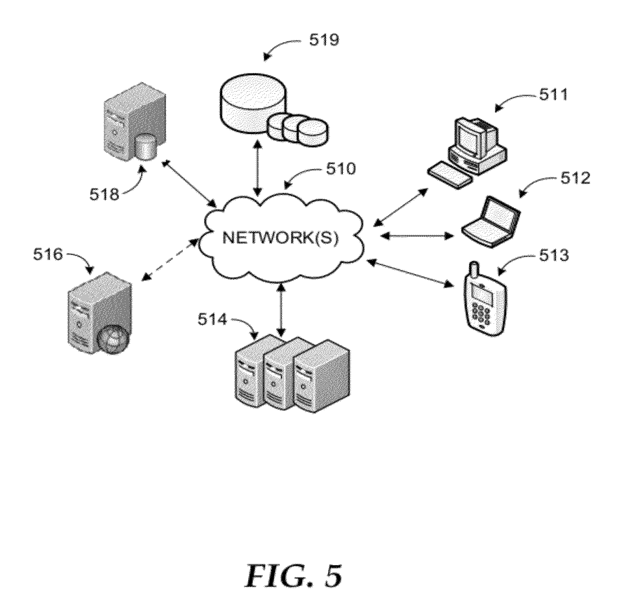

FIG. 5 is an example networked environment, where embodiments may be implemented. Animating a presence indication may be initiated via software executed over one or more servers 514 or a single server (e.g. web server) 516 such as a hosted service. The platform may communicate with client applications on individual computing devices such as a smart phone 513, a laptop computer 512, or desktop computer 511 (‘client devices’) through network(s) 510.

As discussed above, a client application layer may implement an application user interface displaying a presence indication. The initial presence indication may be transitioned to another through an animation executed on the client devices 511-513. Executed animations may be limited to an available subset to meet system requirements.

Client devices 511-513 may enable access to applications executed on remote server(s) (e.g. one of servers 514) as discussed previously. The server(s) may retrieve or store relevant data from/to data store(s) 519 directly or through database server 518.

Network(s) 510 may comprise any topology of servers, clients, Internet service providers, and communication media. A system according to embodiments may have a static or dynamic topology. Network(s) 510 may include secure networks such as an enterprise network, an unsecure network such as a wireless open network, or the Internet. Network(s) 510 may also coordinate communication over other networks such as Public Switched Telephone Network (PSTN) or cellular networks. Furthermore, network(s) 510 may include short range wireless networks such as Bluetooth or similar ones. Network(s) 510 provide communication between the nodes described herein. By way of example, and not limitation, network(s) 510 may include wireless media such as acoustic, RF, infrared and other wireless media.

Many other configurations of computing devices, applications, data sources, and data distribution systems may be employed to animate presence indication transformations. Furthermore, the networked environments discussed in FIG. 5 are for illustration purposes only. Embodiments are not limited to the example applications, modules, or processes.

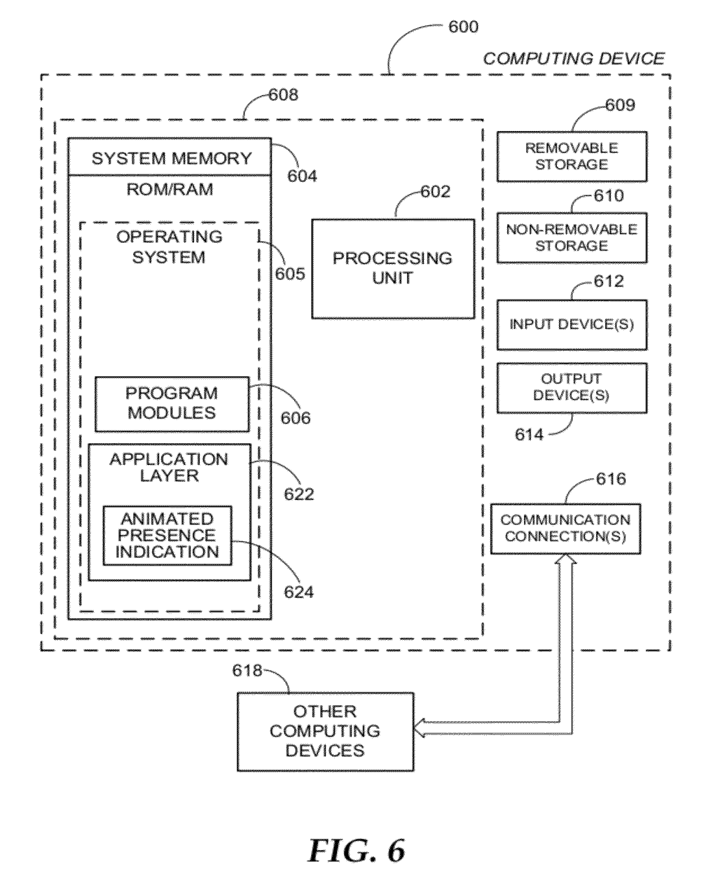

FIG. 6 and the associated discussion are intended to provide a brief, general description of a suitable computing environment in which embodiments may be implemented. With reference to FIG. 6, a block diagram of an example computing operating environment for an application according to embodiments is illustrated, such as computing device 600. In a basic configuration, computing device 600 may be an implementation of query based security policy and include at least one processing unit 602 and system memory 604. Computing device 600 may also include a plurality of processing units that cooperate in executing programs. Depending on the exact configuration and type of computing device, the system memory 604 may be volatile (such as RAM), non-volatile (such as ROM, flash memory, etc.) or some combination of the two. System memory 604 typically includes an operating system 605 suitable for controlling the operation of the platform, such as the WINDOWS® operating systems from MICROSOFT CORPORATION of Redmond, Wash. The system memory 604 may also include one or more software applications such as program modules 606, application layer 622, and animated presence indication module 624.

Application layer 622 may be part of a service that provides presence based services. Animated presence indication module 624 may animate transitioning of an initial presence indication into another upon receiving a presence status update event. Animation may take the form of gradual changing of various properties of graphics and/or text included in the presence indication. This basic configuration is illustrated in FIG. 6 by those components within dashed line 608.

Computing device 600 may have additional features or functionality. For example, the computing device 600 may also include additional data storage devices (removable and/or non-removable) such as, for example, magnetic disks, optical disks, or tape. Such additional storage is illustrated in FIG. 6 by removable storage 609 and non-removable storage 610. Computer readable storage media may include volatile and nonvolatile, removable and non-removable media implemented in any method or technology for storage of information, such as computer readable instructions, data structures, program modules, or other data. System memory 604, removable storage 609 and non-removable storage 610 are all examples of computer readable storage media. Computer readable storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 600. Any such computer readable storage media may be part of computing device 600. Computing device 600 may also have input device(s) 612 such as keyboard, mouse, pen, voice input device, touch input device, and comparable input devices. Output device(s) 614 such as a display, speakers, printer, and other types of output devices may also be included. These devices are well known in the art and need not be discussed at length here.

Computing device 600 may also contain communication connections 616 that allow the device to communicate with other devices 618, such as over a wireless network in a distributed computing environment, a satellite link, a cellular link, and comparable mechanisms. Other devices 618 may include computer device(s) that execute communication applications, storage servers, and comparable devices. Communication connection(s) 616 is one example of communication media. Communication media can include therein computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

Example embodiments also include methods. These methods can be implemented in any number of ways, including the structures described in this document. One such way is by machine operations, of devices of the type described in this document.

Another optional way is for one or more of the individual operations of the methods to be performed in conjunction with one or more human operators performing some. These human operators need not be co-located with each other, but each can be only with a machine that performs a portion of the program.

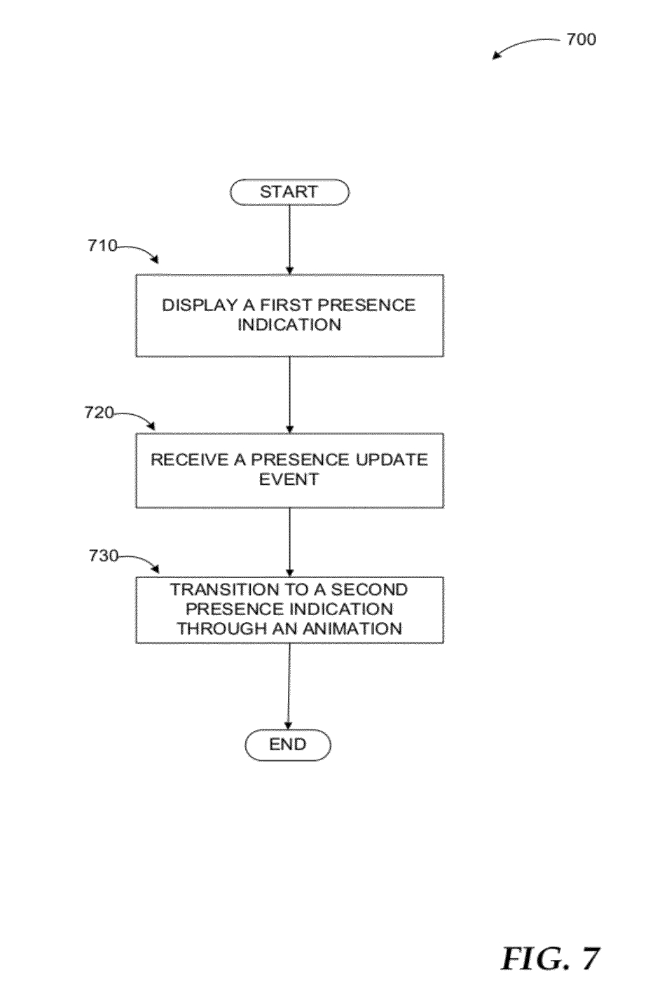

FIG. 7 illustrates a logic flow diagram for process 700 of transitioning a presence indication through animation according to embodiments. Process 700 may be implemented by a client application on any computing device.

Process 700 of a method according to some embodiments may begin with displaying a first presence indication representing a presence status of a contact (710), receiving a presence update event from an external entity (720), and transitioning the first presence indication into a second presence indication in an animated manner if the presence status of the contact is changed based on the presence update event (730). The external entity may be a communications server facilitating communication sessions between client applications in one or more modalities. The animated transition may include animated modification of an icon and/or text associated with the first presence indication. The animated transition may be an appearance style transition, a rotation style transition, a fly-in style transition, a split style transition, a wipe style transition, a fade style transition, and/or a color change style transition.

A rotation style transition may include a complete rotation or a partial rotation. The animated transition may further include a combination of at least one transition style and a color change, a shading change, and/or a size change. The animated transition may also include a color change, shading change, brightness change, or font change of the text.

According to some embodiments, the animated transition may be completed within a preset time period or a dynamically determined time period. The dynamic time period may be computed based on a declining time period or an increasing time period between user interactions with the application.

The transition may also include a blending of the first presence indication into the second presence indication, where the blending forms a plurality of intermediate presence indications sharing properties of the first presence indication and the second presence indication. The properties may include color, shape, size, shading, text, and/or structure.

The animated transition may be selected from a subset of available animations to meet system requirements including power limitations. The presence status may represent a location, availability information, an alternative contact, and/or an organizational information associated with the contact.

According to other embodiments, the animated transition may be selected based on one or more of a default scheme of an application displaying the presence indications, a default scheme of an operating system, and a user selection. The transition may include a combination of a rotation of the first presence indication on at least one of an x, y, and z axes and at least one of an enlargement and a reduction into the second presence indication.

Some embodiments may be implemented in a computing device that includes a communication module, a memory, and a processor, where the processor executes a method as described above or comparable ones in conjunction with instructions stored in the memory. Other embodiments may be implemented as a computer readable medium with instructions stored thereon for executing a method as described above or similar ones.

The operations included in process 700 are for illustration purposes. Transitioning a presence indication through an animation according to embodiments may be implemented by similar processes with fewer or additional steps, as well as in different order of operations using the principles described herein.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method executed at least in part by a computing device providing presence based services, the method comprising:
displaying a first presence indication representing a presence status of a contact;
receiving a presence update event from an external entity; and
if the presence status of the contact is changed based on the presence update event, transitioning the first presence indication into a second presence indication in an animated manner.

2. The method of claim 1, wherein the external entity is a communications server facilitating communication sessions between client applications in one or more modalities.

3. The method of claim 1, wherein the animated transition includes animated modification of at least one of an icon and a text associated with the first presence indication.

4. The method of claim 3, wherein the animated transition includes at least one from a set of: an appearance style transition, a rotation style transition, a fly-in style transition, a split style transition, a wipe style transition, a fade style transition, and a color change style transition.

5. The method claim 4, wherein the rotation style transition includes one of a complete rotation and a partial rotation.

6. The method of claim 4, wherein the animated transition includes a combination of at least one transition style and one of a color change, a shading change, and a size change.

7. The method of claim 3, wherein the animated transition includes one of a color change, shading change, brightness change, and font change of the text.

8. The method of claim 1, wherein the animated transition is completed within one of a preset time period and a dynamically determined time period.

9. The method of claim 1, wherein the animated transition is selected from a subset of available animations to meet system requirements including power limitations.

10. The method of claim 1, wherein the presence status represents at least one from a set of a location, availability information, an alternative contact, and an organizational information associated with the contact.

11. A computing device animating presence symbol updates, the computing device comprising:
a communication module;
a memory;
a processor coupled to the memory, the processor executing an application in conjunction with instructions stored in the memory, wherein the application is configured to:
display a first presence indication representing a presence status of a contact;
receive a presence update event through the communication module; and
transition the first presence indication into a second presence indication in an animated manner completed within a dynamic time period.

12. The computing device of claim 11, wherein the transition includes one of an enlargement and a reduction of the first presence indication into the second presence indication.

13. The computing device of claim 11, wherein the transition includes a blending of the first presence indication into the second presence indication.

14. The computing device of claim 13, wherein the blending forms a plurality of intermediate presence indications sharing properties of the first presence indication and the second presence indication.

15. The computing device of claim 14, wherein the properties include at least one from a set of: color, shape, size, shading, text, and structure.

16. The computing device of claim 11, wherein the dynamic time period is computed based on one of a declining time period and an increasing time period between user interactions with the application.

17. The computing device of claim 11, wherein the transition includes one of a texture transformation, a color change, and a shading scheme change.

18. A computer-readable storage medium with instructions stored thereon for animated display and update of presence information, the instructions comprising:
displaying a first presence indication representing a presence status of a contact;
receiving a presence update event from a communication server; and
if the presence status of the contact is changed based on the presence update event, transitioning the first presence indication into a second presence indication in an animated manner modifying at least one of an icon and a text associated with the first presence indication.

19. The computer-readable storage medium of claim 18, wherein the animated transition is selected based on one or more of a default scheme of an application displaying the presence indications, a default scheme of an operating system, and a user selection.

20. The computer-readable storage medium of claim 19, wherein the transition includes a combination of a rotation of the first presence indication on at least one of an x, y, and z axes and at least one of an enlargement and a reduction into the second presence indication.
